(19) United States
(12) Patent Application Publication
(10) Pub. No.: US 2011/0116205 A1
(43) Pub. Date: May 19, 2011

(54) Collector electrodes for an ion wind fan

(75) Inventor: Daniel J. SCHLITZ, Marietta, GA (US)

(73) Assignee: VENTIVA, INC., Santa Clara, CA (US)

(21) Appl. No.: 12/885,189

(22) Filed: Sep. 17, 2010

Related U.S. Application Data
(60) Provisional application No. 61/243,965, filed on Sep. 18, 2009.

(51) Int. Cl. H01T 23/00

(52) U.S. Cl. 361/230

(57) ABSTRACT

In one embodiment, an ion wind fan includes a wire emitter electrode held in tension and a collector electrode having a row of openings oriented along the direction of the row of openings, the openings having an elongated oval shape having a straight portion and a rounded portion. In one embodiment, the wire emitter electrode and the collector electrode are attached to an isolator so that the row of openings is substantially centered above the wire emitter electrode.

### CROSS-REFERENCE TO RELATED APPLICATIONS

This application claims the priority benefit of U.S. Provisional Patent Application No. 61/243,965 entitled “EMITTER AND COLLECTOR ELECTRODES FOR ION WIND FAN,” which is hereby incorporated by reference in its entirety.

### FIELD OF THE INVENTION

The embodiments of the present invention are related to ion wind fans, and in particular to a collector electrode for an ion wind fan.

### BACKGROUND

It is well known that heat can be a problem in many electronics device environments, and that overheating can lead to failure of components such as integrated circuits (e.g. a central processing unit (CPU) of a computer) and other electronic components. Most electronics devices, from LED lighting to computers and entertainment devices, implements some form of thermal management to remove excess heat.

Heat sinks are a common passive tool used for thermal management. Heat sinks use conduction and convection to dissipate heat and thermally manage the heat-producing component. To increase the heat dissipation of a heat sink, a conventional rotary fan or blower fan has been used to move air across the surface of the heat sink, referred to generally as forced convection. Conventional fans have many disadvantages when used in consumer electronics products, such as noise, weight, size, and reliability caused by the failure of moving parts and bearings.

A solid-state fan using ionic wind to move air addresses the disadvantages of conventional fans. However, providing an ion wind fan that meets the requirements of consumer electronics devices presents numerous challenges not addressed by any currently existing ionic wind device.

### BRIEF DESCRIPTION OF THE DRAWINGS

FIG. 1 is a perspective view of a prior art needle-type emitter and mesh-type collector ion wind device;

FIG. 2 is a perspective view of a prior art wire-type emitter and rod-type collector ion wind device;

FIG. 3 is a cross-sectional view of a prior art needle-type emitter and mesh-type collector ion wind device;

FIG. 4A is a top plan view of a collector electrode according to one embodiment of the present invention;

FIG. 4B is a cross-sectional view of the collector electrode of FIG. 4A according to one embodiment of the present invention;

FIG. 5A is a downstream view of an ion wind fan according to one embodiment of the present invention;

FIG. 5B is a cross-sectional view of the ion wind fan of FIG. 5A according to one embodiment of the present invention;

FIG. 5C is an upstream view of the ion wind fan of FIG. 5A according to one embodiment of the present invention;

FIG. 6 is a perspective view of the ion wind fan of FIG. 5A according to one embodiment of the present invention;

FIG. 7A is a cross-sectional view of a collector electrode according to one embodiment of the present invention;

FIG. 7B is a top plan view of the collector electrode of FIG. 7A according to one embodiment of the present invention;

FIG. 7C is a perspective view of a collector electrode according to one embodiment of the present invention;

FIG. 8A is an electrical field representation between the electrodes of an ion wind device according to one embodiment of the present invention;

FIG. 8B is an electrical field representation between the electrodes of another ion wind device according to one embodiment of the present invention;

FIG. 9A is a upstream view of a collector electrode according to one embodiment of the present invention;

FIG. 9B is a downstream of the collector electrode of FIG. 7A according to one embodiment of the present invention;

FIG. 9C is a perspective view of a collector electrode according to one embodiment of the present invention;

FIG. 9D is a perspective view of an ion wind fan according to one embodiment of the present invention;

FIG. 9E is a cross-sectional view of the ion wind fan of FIG. 9D according to one embodiment of the present invention;

FIG. 10A is a perspective view of a shim emitter electrode according to one embodiment of the present invention;

FIG. 10B is a side view of the shim emitter electrode of FIG. 10A according to one embodiment of the present invention;

FIG. 11A is a cross-sectional view of an ion wind fan according to one embodiment of the present invention;

FIG. 11B is a upstream view of the ion wind fan of FIG. 11A according to one embodiment of the present invention, with the collector electrode omitted from the Figure;

FIG. 11C is a close-up cross-sectional view of the ion wind fan of FIG. 11A according to one embodiment of the present invention;

FIG. 12A is flow diagram illustrating a process for ion wind fan production according to one embodiment of the present invention;

FIG. 12B is flow diagram illustrating another process for ion wind fan production according to one embodiment of the present invention;

FIG. 13A is a cross-sectional view of an ion wind fan according to one embodiment of the present invention;

FIG. 13B is a perspective view of the ion wind fan of FIG. 13A according to one embodiment of the present invention;

FIG. 14A is a cross-sectional view of an ion wind fan according to one embodiment of the present invention; and

FIG. 14B is a perspective view of the ion wind fan of FIG. 13A according to one embodiment of the present invention.

### DETAILED DESCRIPTION

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode or collector electrode.

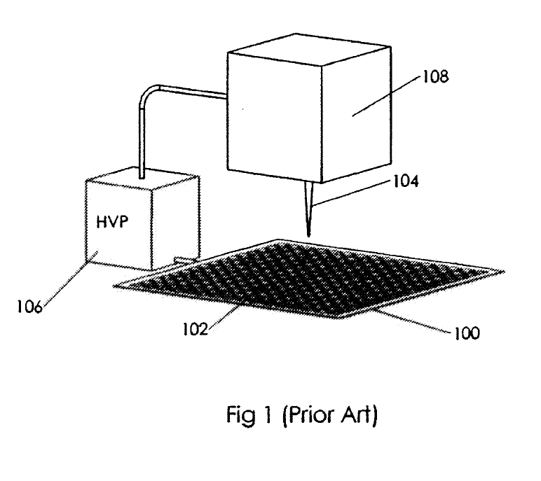

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. Such a prior art configuration disclosed by Shannon, et al. is illustrated by FIG. 1. In FIG. 1, a metal mesh screen 102 is held by a frame 100. The metal mesh screen 102 acts as he collector electrode. A metal needle 104 is positioned on some structure 108 so that it points perpendicularly at the metal mesh screen 102. A high voltage power supply 106 is conductively coupled to the metal mesh screen 102 and the needle 104. The high voltage power supply 106 provides a high potential difference across the needle 104 and the mesh 102, thereby creating ion wind from the point of the needle 104 towards the metal mesh collector 102, as described in more detail in Shannon, et al ('847).

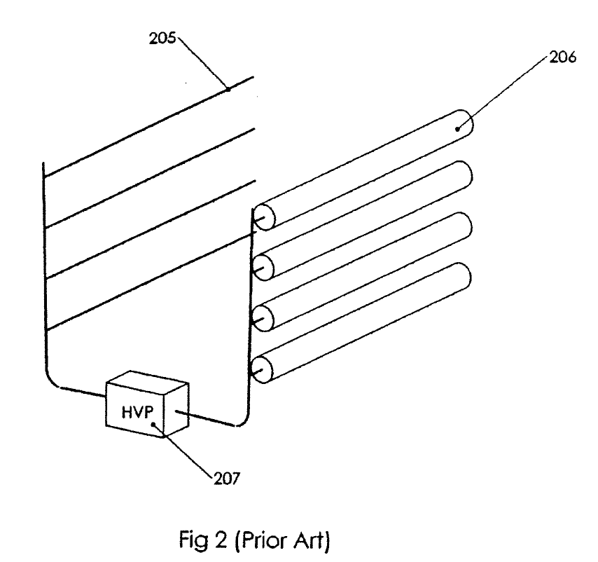

U.S. Pat. No. 7,122,070 to Krichtafovitch, dated Oct. 17, 2006, describes a wire to bar electrode geometry—illustrated by FIG. 2—where a wire is used as the sharp electrode and a metal bar is used as the blunt electrode. U.S. Pat. No. 4,689,056 to Noguchi et al., which dates back to 1987, also discloses a substantially similar wire to bar configuration, except the bars are referred to as rods. FIG. 2 illustrates the prior art configuration disclosed in Noguchi et al. and Krichtafovitch. FIG. 2 shows four wire emitter electrodes 205 and four bar-shaped collector electrodes 206 forming four emitter-collector pairs. Each pair is oriented so that the four emitters 205 are coplanar with each other, and each emitter 205 is coplanar with its corresponding collector electrode 206.

The bar collector electrodes 206 are also coplanar with each other, and the planes of the emitters and the collectors are parallel with each other, and perpendicular with the planes of the emitter-collector pairs. Thus, FIG. 2 shows four instances of the prior art wire-to-rod geometry in which a wire is stretched lengthwise along the length of a bar with a gas gap between the two. The high voltage power supply 207 provides the voltage potential to initiate ion creation along the length of the wire emitters 205.

One challenge to the closer spacing of the corona electrode to the collector electrode, is that to create ion wind, it is desirable to have a high electric field strength at the corona electrode and a low electric field strength at the collector electrode. Furthermore, the high voltage emitter can also interfere with each other, making it difficult to space corona wires or emitter electrodes in general in close proximity.

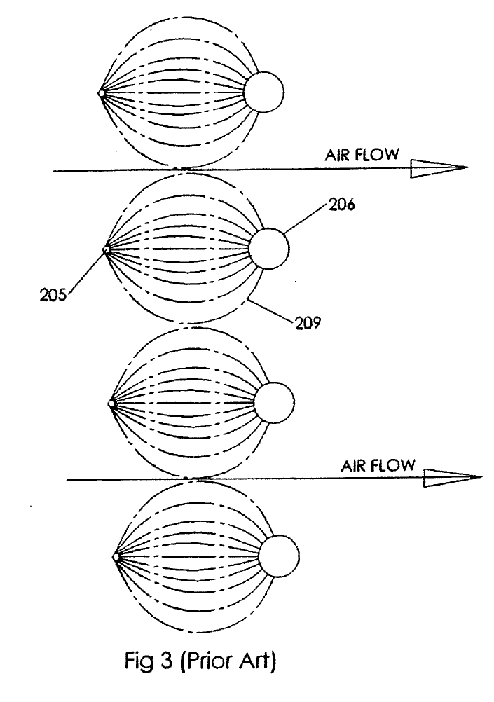

Since electric fields tend to be stronger around sharp points, corona electrodes have been implemented as sharp points, the edges of blades, or thin wires, while collector electrodes have been implemented as mesh screens, larger bars or rods, or solid plates. For example, the electric field around a corona wind device having several wire corona/bar collector electrode pairs—for example the geometry shown in FIG. 2—is now described with reference to FIG. 3. FIG. 3 is a cross-sectional side view of the emitter wires 205 and the collector bars 206 under a high voltage potential that creates an electric field. The electric field is represented visually by electric field lines 209. The electric field lines show paths of travel for ions created at the emitter 205. Not every possible electric field line 209 is illustrated in FIG. 3 for simplicity and ease of understanding.

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

### Flat Plate Collector Electrode Having Air Passage Openings

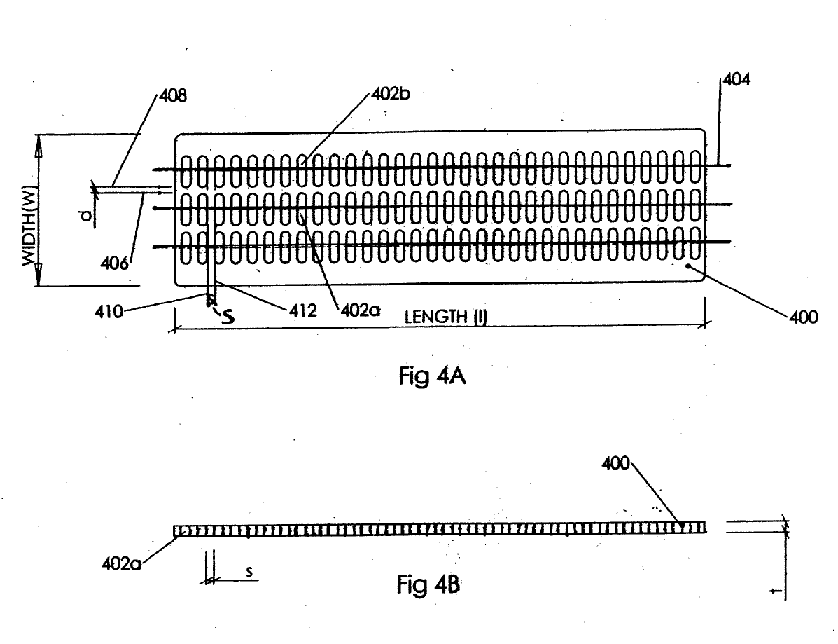

FIGS. 4A and 4B illustrate a “collector electrode” for an ion wind fan according to one embodiment of the invention. FIG. 4A is a top view of one embodiment of a collector electrode 400. The collector electrode 400 is shown in FIG. 4A as having a substantially rectangular shape defined by a length (l) and a width (w). As shown in FIG. 4B, the collector electrode also has a thickness (t). However, the collector electrode 400 may have other top-view profiles, such as square, L-shaped, circular, or oval, and there may be attachment portions extending from the active surface of the collector electrode 400.

The collector electrode 400 has a number of openings 402 through the electrode 400. In one embodiment, the openings are arranged in distinct rows so that the centers of the openings of one row are substantially aligned with a line parallel to the lengthwise edge of the collector electrode 400. For example, in FIG. 4A, three distinct rows of openings are shown, the openings in one of the rows being labeled 402a and the openings in the adjacent row being labeled 402b. As an example, the openings 402b are shown to be aligned with dotted line 404.

In the embodiment illustrated by FIG. 4A, the openings 402 are substantially slot-like with rounded ends. Each opening 402 has a substantially rectangular center portion with two rounded portions on each end. In the embodiments shown the rounded portions are a full 180 degree radius connecting the two parallel sides of the openings. In other embodiments, various rectangular shapes having fillet corners can be used. In one embodiment, the center rectangular portion of each opening 402 is larger in area than the rounded end portions by a factor of between two to six. However in other embodiments, the openings can be rectangular, hexagonal, or oval, in addition to several other geometric shapes.

In one embodiment, the openings of two distinct rows are separated by each other by some distance (d) over which there are no openings 402 on the collector electrode 400. In FIG. 4A, this is illustrated as the area between dotted lines 406 and 408. The spacing between each opening 402 in a row of openings is represented in FIG. 4A by spacing distance (s), shown as the space between dotted lines 410 and 412.

The pitch between openings 402 is defined as the distance from the center of one opening to the center of an adjacent opening in the same row. It is to be noted that the pitch includes the spacing distance s. In one embodiment, the relationship of the pitch to the spacing distance s is that the pitch is approximately five (5) times the spacing distance.

For example, in one embodiment the pitch is 1 mm and the spacing distance is 0.2 mm. This results in the active area of the collector electrode 400 being approximately 80% open. In one embodiment, the pitch and spacing distance is selected to make the percentage opening—the surface area of the collector electrode 400 comprised of openings 402—in the range of 70-90% open. In one embodiment, the row separation distance d is approximately the same as the spacing interval s, although in other embodiments they can be unrelated.

FIG. 4B is a lengthwise side-view of the collector electrode 400. As can be seen from FIG. 4B, the collector electrode 400 is substantially flat over both its top portion (the surface facing the emitter electrodes) and its bottom portion. Furthermore, the collector electrode 400 has a substantially uniform thickness, so that the openings 402 all have substantially the same depth, equal to the thickness (t) of the collector electrode 400.

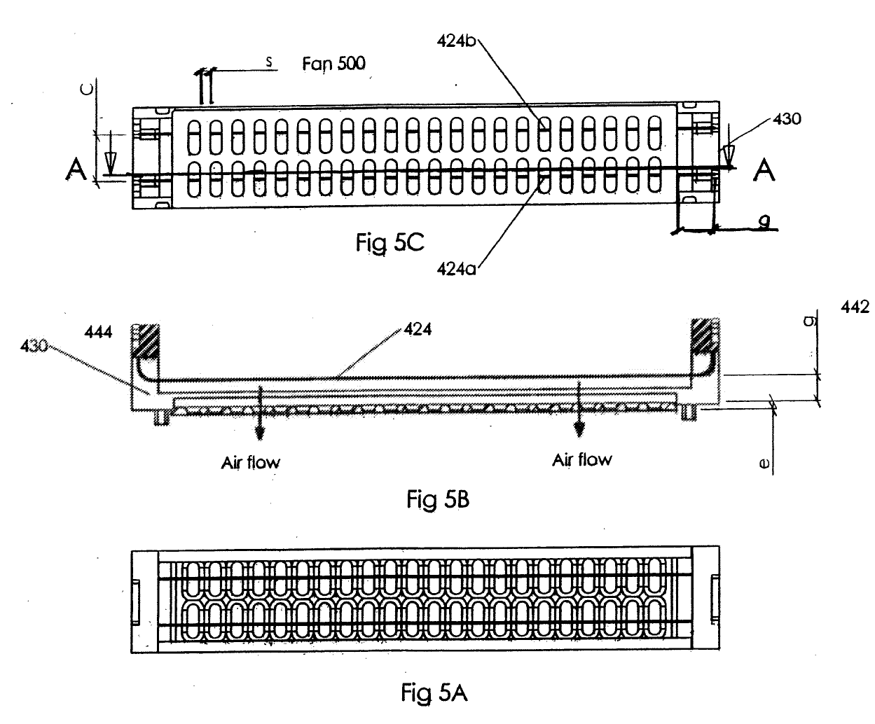

One embodiment of the present invention is now described with reference to FIG. 5A and FIG. 5B. FIG. 5A is a rear-view (“downstream view”) of an ion wind fan 500 using a collector electrode 400 described with reference to FIGS. 4A and 4B and wire corona electrodes. The view is upstream as the airflow is directed from the corona electrodes toward to collector electrode and the view is facing in the upstream direction.

The collector electrode 400 is supported by a support structure 420. Corona wires 424 are supported by a second support structure 422. In one embodiment, the two support structures are joined together or constructed from one piece, so that the same support structure (collectively referred to by the numeral 430) holds the corona wires 424 as well as the collector electrode 400. This support structure 430 is made out of a dielectric material, such as plastic, and will sometimes be referred to herein as the “isolator” 430.

In the embodiment shown in FIG. 5A, the corona electrodes 424 and the collector electrode 400 are attached to the isolator 430 element is such a manner, that the isolator 430 holds each corona electrode wire 424 in tension above a row of openings 402 on the collector electrode 400. For example, the corona electrode wire 424b is held in tension by the isolator 430 so that a plane containing the corona wire 424b and perpendicular to the collector electrode 400 would substantially bisect the openings 402b that are aligned in a row. In other words, in one embodiment the corona wires 424 are substantially centered in relationship to the rows of openings, with one row of openings per corona wire 424.

Corona electrode 424a is similarly positioned by the isolator 430 above openings 402a that are aligned in a row. Thus, the spacing between the corona electrodes 424—represented in FIG. 5A by the quantity (c)—can be approximately be thought of as the lengthwise diameter of the openings 402 plus the distance d between the rows of openings 402.

In the embodiment shown in FIG. 5A, the openings 402 are in the shape of slots or slits, which are rectangular shaped openings with rounded sides along their width. This geometry will also be referred to as an “elongated oval,” even though it is not technically an oval shape. In other embodiments, actual oval opening can be used.

One advantage of slit shaped openings 402 is that they are simple to manufacture. Another advantage of slit shaped openings 402 is that their rounded edges in the plane of the top surface of the collector electrode 400 (the surface facing the corona electrodes 424) help in lowering the electric field strength at the collector electrode 400, since electric fields tend to focus around sharp objects. As shown in the Figures, the openings 402 are rectangular and have fillet corners. In the Figures, the fillet corners provide a full radius that connects the two lengthwise sides of the rectangular openings. Other fillet corners can be used in other embodiments.

The distance that the corona electrodes 424 are held above the collector electrode 400 is represented by the quantity (g) in FIG. 5A. g can be though of as the gas gap (air gap) between the corona and collector electrodes. While the various distance quantities represented by letters in the FIGS. 4-5 described above can have a certain amount of variance, some guidelines help operate the ion wind fan more efficiently. For example, the gas gap (g) is related to the maximum diameter of the emitter electrode. While no simple to express relationship exists, some observed example values are shown in Table 1 below.

TABLE 1

| Gas Gap (g) | Maximum Emitter Wire Diameter |
|---|---|
| 10 mm | 1800 μm |
| 5 mm | 1000 μm |
| 2 mm | 140 μm |
| 1 mm | 40 μm |

It should be noted that the values in Table 1 are approximate, and apply only to smooth bare wire corona electrodes using DC power for negative corona wind. They are provided here merely as example size ranges, and do not limit any aspects of the inventions disclosed herein to these specific size ranges.

There are numerous possible designs for the isolator 430 element. For simplicity and ease of understanding, only simple isolator designs are described herein, such as a rectangular frame of thickness t, or two dielectric columns attached to either end of the collector 400 across which the corona wires 424 can be stretched. For the purposes of the present Application, the collector 400 and corona electrodes 424 are all attached to the isolator 430, such that the isolator 430 established the geometric relationship between the electrodes.

FIG. 5B shows a side-view of the ion wind fan 500 rotated such that the corona electrodes 424 are on the top, and the ionic airflow would be directed downward (on the page). As can be seen from FIG. 5B, in one embodiment the side-most corona wire is attached to the isolator at attachment points 442 and 444. The corona wires can be attached to the isolator 430 using heat stakes, screws, or any other conventional wire attachment technique. The total height of the ion wind fan 500 as shown in FIG. 5B is the thickness of the isolator 430 and the collector 400, although the height can be decreased up to the sum of the thickness of the collector 400 (t) and the gas gap (g), since the thickness of the wire can be regarded as minimal.

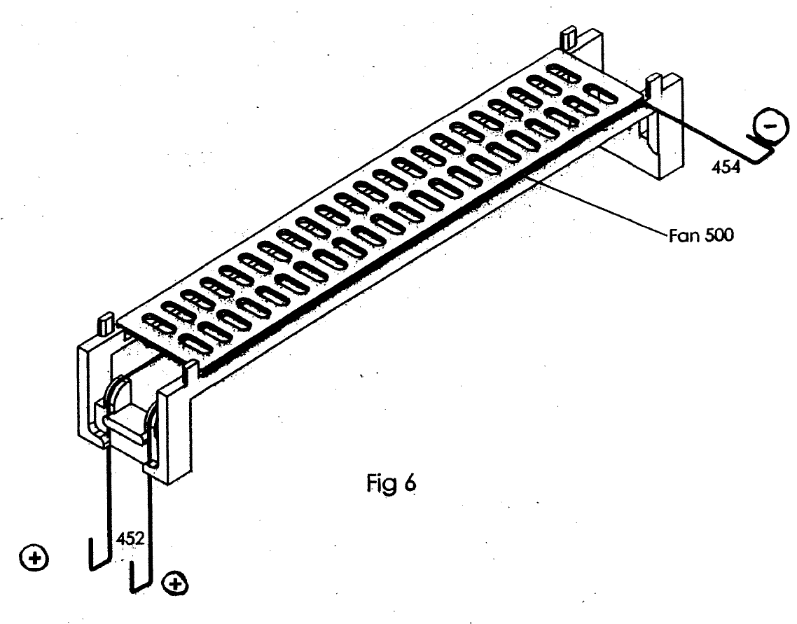

Similarly, FIG. 5C shows a frontal view (“upstream view”) of the ion wind fan 500, illustrating the attachment of the collector electrode 400 to the isolator 430. The collector 400 can be attached to the isolator 430 using screws, snapping, glue, or other such conventional attachment means. FIG. 6 shows a perspective front view of an ion wind fan 500. The ion wind fan 500 includes a connection location 452 to receive a connection to the positive terminal of a high voltage power source and another connection location 454 to receive a connection to the negative terminal of the high voltage power source. The connection location 452 is internally conductively connected to the corona electrodes 424, while the connection location 454 is internally conductively connected to the collector electrode 400.

It can be noted with reference to FIG. 6, that the “top” portion of the collector 400 facing the corona electrodes 424 is actually facing the back of the ion wind fan 500 in the opposite direction to airflow. The airflow exits the ion wind fan 500 through the openings 402 in the direction away from the bottom portion of the collector 400, such bottom portion also representing the front of the ion wind fan 500.

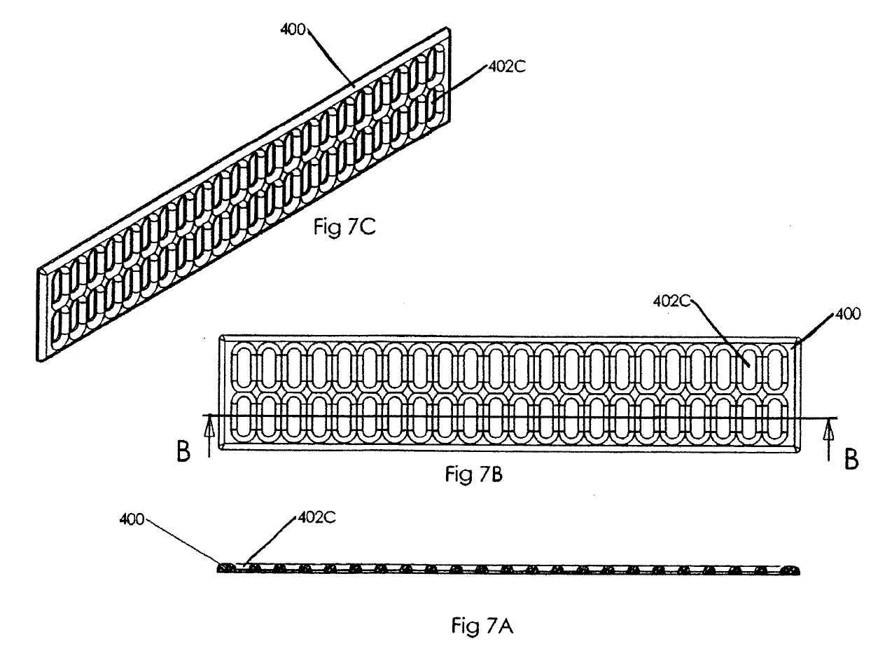

Another embodiment of the present invention is now described with reference to FIG. 7A-C. FIG. 7A shows a lengthwise cross-section of the collector electrode 400 along the dotted line B shown in FIG. 7B. The openings 402c of the collector electrode are rounded, so that on the top surface of the collector 400 (facing the emitter electrodes), the openings present a rounded profile and no sharp edges. FIGS. 7B (top view) and 7C (frontal perspective view) further illustrate the rounded nature of the openings 402c. In other words, in addition to having rounded edges in the plane of the collector electrode 400, the opening 402c is also rounded in the direction from the top surface of the collector electrode 400 to the bottom surface of the collector electrode 400.

In the embodiment shown in FIG. 7, the edge of the openings 402c are only rounded on the portion (side) of the collector electrode that is facing the corona electrodes 424, otherwise referred to herein as the top portion. In another embodiment, both top and bottom portions of the collector 400 have openings 402c rounded such that any line from one side of the collector to the other side of the collector 400 through the opening 402c would not traverse a sharp edge.

In one embodiment, the opening 402c is only rounded along the straight or rectangular portion of a slit like opening 402c that is parallel with the width of the collector electrode 400. In another embodiment—as shown in FIG. 7—the entire circumference of the edge of opening 402c is thus rounded.

Such opening as described with reference to FIG. 7 can be used for some or all of the openings disposed on the collector electrode 400. A collector electrode 400 as described in the embodiments above can be made from any metal, including aluminum, steel, copper, nickel, and silver. The collector can be machined or stamped from a single flat plate of metal.

### Wire/Rod-Type Collector Electrode for Ion Wind Fan

As can be seen from the Noguchi (U.S. Pat. No. 4,689,056) and Krichtafovitch (U.S. Pat. No. 7,122,070) patents mentioned above, as well as the descriptions of FIG. 2 and FIG. 3 above, prior art systems using a bar or rod as a collector electrode simply replicate the wire-to-rod geometry several times to increase air flow. Thus, in prior art ion wind descriptions, there is either the same number of corona electrodes as collector electrodes, such as the corona-collector pair described in Krichtafovich, or there are even more corona electrodes than collector electrodes, as shown in FIG. 5 of Noguchi. As can be seen in FIG. 3, the electric field in such an electrode configuration has a substantial sideways component. In other words, some ions spend significant portions of the path to the collector traveling at large angles away from the direction of desired airflow, thus moving air in directions not substantially parallel with the desired airflow. For ease of understanding, arrows in FIG. 3 show the direction of desired airflow. This reduces the maximum obtainable airflow and is an inefficient use of the ions generated at the emitter electrodes.

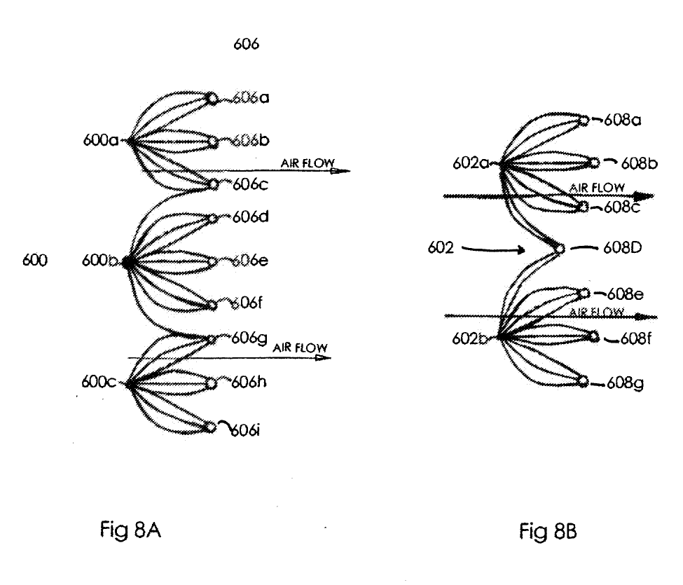

In one embodiment of the present invention, the collector electrode is made up of a number of rods or wires, but the number of the rods that make up the collector electrode is significantly greater than the number of coronal electrodes. In one embodiment, the number of collector electrodes (col) is an integer multiple of the number of coronal electrodes (cor). Mathematically this can be expressed as col=a*cor, where a>=2. For example, an embodiment in which cor=3 and a=3 is now described with reference to FIG. 8A.

FIG. 8A is a schematic side view of an electrode geometry inside an ion wind fan according to one embodiment of the present invention. For simplicity and ease of understanding, only the electrodes and the electric fields they can create are shown in FIG. 8A, omitting various other structures and components of the ion wind fan.

There are three corona electrodes 600a, 600b, 600c. As described above, the corona electrodes ionize the air in their vicinity in response to a high voltage potential. The ions thus generated move towards the collector electrodes 606a-606i along the electric filed lines, some of which as illustrated in FIG. 8A. Sometimes, this set of collector electrodes 606a-i is referred to simply as the collector electrode 606.

In this embodiment, since there are three corona electrodes 600, and there are three times as many collector electrodes 606, there are nine collector electrodes shown in FIG. 8A. There are several advantages of such an electrode geometry. The electric field lines from a coronal electrode to several collector electrodes are oriented significantly more along the direction of desired airflow.

For example, the electric field lines from corona electrode 600b to collector electrodes 606c-606g can be seen as being more forward directed than the electric field lines shown in FIG. 3. A similar effect cannot be achieved by simply moving the corona wires closer together, as the high voltage corona wires would interfere with each other if moved too close together. In one embodiment, the spacing between the corona electrodes 600 is at least 2 mm, as performance begins to degrade if corona electrodes are spaced more closely together.

The collector electrodes 606 are not subject to such spacing limitations, but each collector electrode 606 does obstruct airflow to a certain extent. Therefore, the integer multiple a can be set to not have an excessive number of collector electrodes 606. For some ion wind fan applications, for example, a<5. Other advantages of providing multiple collector electrodes for each corona electrode include lower electric field strength at the collector electrodes that reduces the likelihood of sparks between corona and collector electrodes, and a reduction in the number of corona electrodes 600 that could interfere with one another.

In the embodiment shown in FIG. 8A, there are three times as many collector electrodes 606 as corona electrodes 600 (a=3). Furthermore, there are three corona electrodes 600 shown. However, the invention is equally applicable to any number of corona electrodes 600, and any integer multiplier (a) greater than or equal to two. In one embodiment, the collector electrodes are made of aluminum, but other metals and metal alloys can be used, such as steel, copper, nickel, and silver.

According to another embodiment, the number of collector electrodes (col) is greater than an integer multiple of the number of coronal electrodes (cor). Mathematically this can be expressed as col>a*cor, where a>=2. By adding additional collector electrodes the performance of the fan may be balanced more evenly.

Yet another embodiment for an ion wind fan electrode geometry is shown in and described with reference to FIG. 8B. In FIG. 8B, the collector electrodes 608 are distributed so that each collector electrode 608a-g is located at a substantially constant distance (g representing the gas gap) from the corona electrode 602 from which it is receiving ionic current.

Since electric field lines cannot cross, in the example shown in FIG. 8B, collector electrodes 608e-608g only collect ions generated around corona electrode 602b, collector electrodes 608a-608c only collect ions generated around corona electrode 602a, and collector electrode 608d collects ions generated around both corona electrodes 602a and 602b. Thus, in one embodiment, the collector electrodes 608 are disposed on an arc of a substantially constant radius about the corona electrode from which they collect ions.

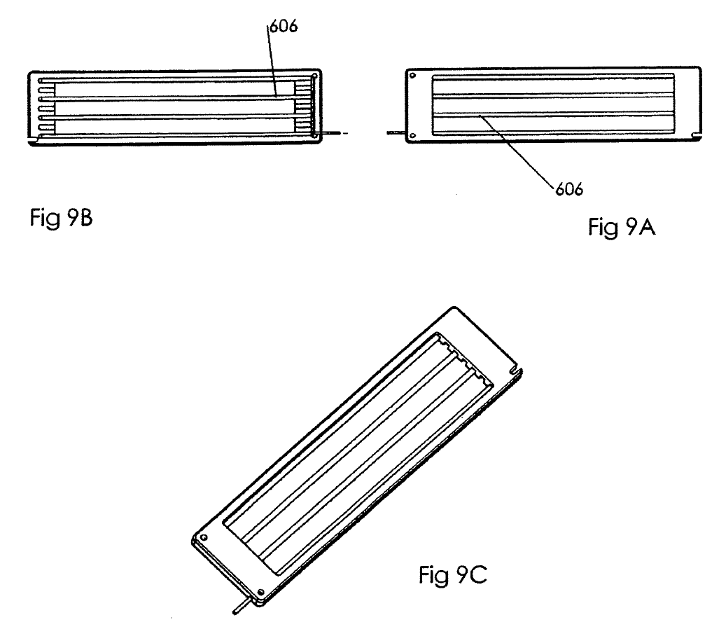

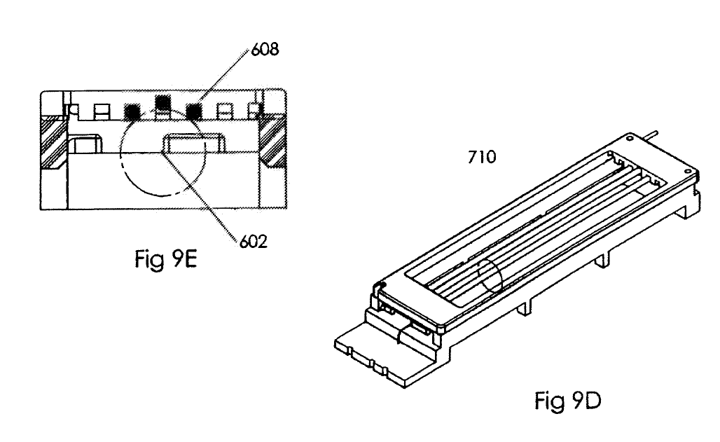

Such a geometry can further reduce the electric field strength around the collector electrodes 608. The number of electrodes for such arc-situated electrodes can vary, and not every arc need contain the same number of collector electrodes 608. In one embodiment, to keep the collector-to-corona ratio even, the number of electrodes can be expressed mathematically as: col=(a*cor)−(cor−1), where a>=3. For example, in FIG. 8B, the number is collectors (7) is derived as (4*2)−(2−1)=7; where a=4. FIGS. 9A-9C show various views a collector component having a number of rod/wire-type collector electrodes situated in a single plane acting as the collector electrode. Placing the collector electrodes in this manner simulated the electric field around a blunt plane, but still allows the passage of air to enable airflow.

FIGS. 9D and 9E show an ion wind fan 710 with an electrode geometry like those described with reference to FIG. 8B.

### Shim Emitter Electrodes for Ion Wind Fan

As has been described further above, emitter electrodes (also referred to as corona electrodes) have been conventionally implemented in laboratory environments as pins, wires, or blades. A blade is a substantially triangular-shaped slab of metal with a sharpened edge. However, each of these types of corona electrodes has disadvantages when used in a mass produced ion wind fan, where cost of construction can become an important consideration. For example, wires, especially very thin wires, can be difficult to handle by automated assembly machines. Blades, on the other hand, must be individually machined at some expense and time cost.

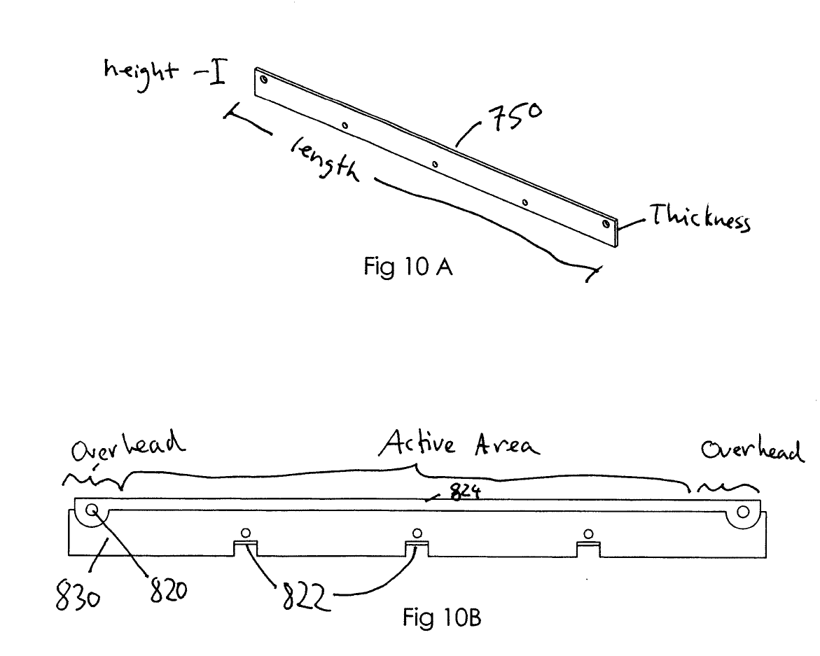

One embodiment of the present invention is now described with reference to FIG. 10A. FIG. 10A is a magnified perspective view of a metal shim 750 that can be used as a shim corona electrode 750. The shim electrode 750 has a length (l), a height (h), and a thickness (t). When used as a corona electrode, the thickness (t) of the shim electrode 750 will generally be almost negligible when compared to its length (l) and height (h). For example, the thickness of the shim electrode is in the range of 0.025-0.01 mm, while the height of the shim electrode is in the range of 2-6 mm. The length of the shim electrode is application dependent, but is generally in the multiple centimeter range, such as 2-20 cm.

The shim electrode 750 can be made of numerous metals, such as copper, nickel, silver, aluminum, tungsten, or other alloys and metal combinations, and other such conductors. One advantage of using shims for emitter electrodes is that various metals are sold in shim form by metal merchant companies, thus making the process of sizing an electrode from a shim simple and cost effective. The electrodes can either be ordered in custom shim sizes, or they can be stamped by a custom die tool from sheets of metal having the desired shim thickness (t).

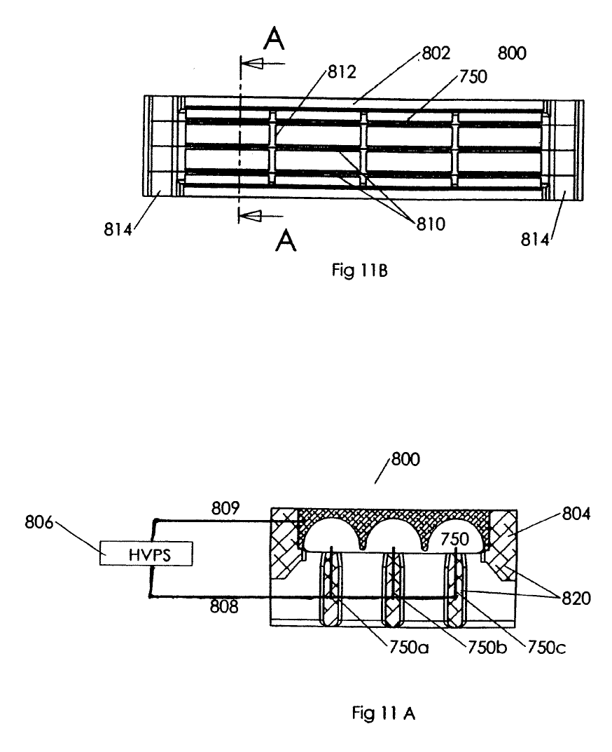

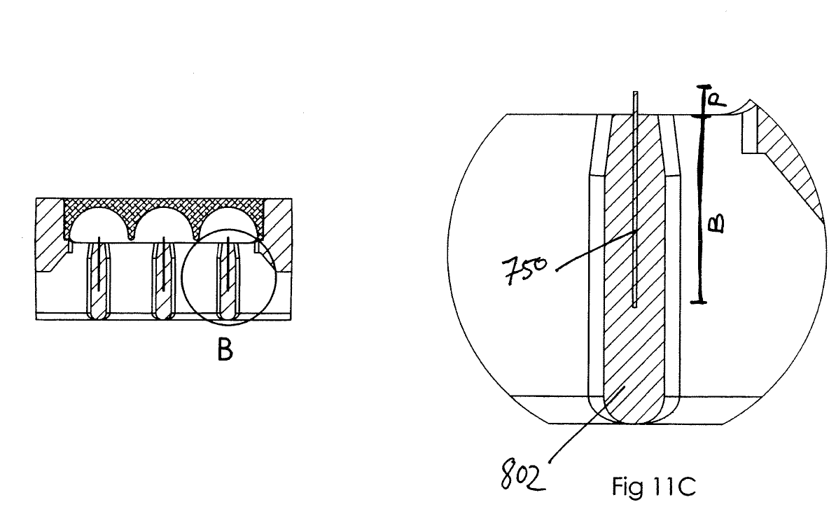

Since a shim electrode 750 is thin, it needs some form of structural support when used as an emitter electrode in an ion wind fan. One embodiment of such an ion wind fan implementing shim corona electrodes is now described with reference to FIG. 11A. In FIG. 11A, the ion wind fan 800 is shown as having three corona electrodes 750a-750c that are implemented as three shims embedded into the isolator 802. The collector electrode 804 is also attached to the isolator 802. The collector electrode 802 can be implemented in any of the ways described above, in addition to any conventional and future collector electrode designs.

Since FIG. 11A is a cross-sectional side view (cross-section along line A in FIG. 11B) of the ion wind fan 800, the shim electrodes 750 are viewed in side profile and represented as lines, since the thickness of such shims can render them almost invisible in side view profile to the naked eye. The shim corona electrodes are connected to a high voltage power supply 806 via electrical lines 808 and the collector electrode 804 is connected to the high voltage power supply 806 via electrical line 809. The provision of a high voltage potential across the corona and collector electrodes from the high voltage power supply produces ion wind as explained above, since ions will be generated along the sharp edges of the shim electrodes 750 protruding from the isolator 802 in response to the applied voltage.

As shown in FIG. 11A, the shim electrodes 750 are partially buried and partially protruding from the isolator element 802. As explained above, the isolator 802 is the dielectric support structure that holds the various electrodes of the ion wind fan 800 in place and established their relationship to each other. In other words, the electrodes are all attached to or in some way disposed on the isolator 802.

The distance that a shim corona electrode 750 is buried in the isolator 802 is represented by the quantity (b) in FIG. 11C. The distance that a shim corona electrode 750 protrudes from the isolator 802 is represented by the quantity (p) in FIG. 11C. While there are various acceptable values for p and b, in laboratory tests fan performance is improved when the value of p is between 0.2-1 mm. However, the value of p is dependent upon the thickness (t) of the shim electrode 750, so there is no one ideal value for p. In one embodiment, the shim electrode 750 protrudes 0.3-0.5 mm for a 3 mil (about 75 micron) thick shim. While the value of b is not as sensitive and does not affect fan performance as much asp, the total shim height is usually in the range of 2-4 mm.

The spacing between shim corona electrodes 750 is represented by the quantity (s) in FIG. 11A. In one embodiment, the distance (s) between any two adjacent shim corona electrodes 750 is substantially equal, but spacing can be variable according to other embodiments of the present invention. As explained above, high voltage corona electrodes can interfere with one another when placed adjacent to each other, thereby lowering the performance of the ion wind fan.

Therefore, one additional advantage of using shim corona electrodes 750 as opposed to using blade-type corona electrodes is that the corona electrodes can be placed closer together, since the bottom of the shims is not substantially wider than the tip of the shims. By being able to place corona electrodes in closer proximity to one another—essentially decreasing the possible value of s—more corona electrodes can be provided in a given space, thus possibly increasing ion production and fan performance.

FIG. 11B is a top plan view of the ion wind fan 800. The collector electrode 804 is not shown for simplicity and ease of understanding. The isolator 802 has lengthwise shim support members 810 to house and support the shim corona electrodes 750. The shim support members 810 can be integrally formed from one plastic piece with the rest of the isolator body, for example, by injection molding plastic or another dielectric material.

While keeping the shim support members 810 as thin as possible will increase potential airflow trough the ion wind fan 800, making the shim support members 810 thicker will stiffen the chassis of the ion wind fan 800, will be less prone to damage, and will be easier to manufacture. While the desired thickness of the shim support members 810 will depend on specific implementation factors such as the dielectric material used for the isolator 802 (which includes the shim support members 810) and the thickness of the shim emitter electrodes being supported by the shim support members 810, in one example, the shim support members are approximately 0.5-2 mm thick.

According to one embodiment, the shim support members 810 have an areo-dynamic profile, as can be seen in FIG. 11A. The top portion of the shim support members 810 can be tapered to assist airflow. In another embodiment, both top and bottom portions of the shim support members 810 are tapered to assist airflow. In yet another embodiment, the shim support members 810 are wing-shaped.

Also shown in FIG. 11B are stiffening cross-members 812. These cross-members are optional, and can be omitted in some embodiments. Cross-members 812 cross the isolator 802 in a widthwise direction and function to stiffen the chassis of the ion wind fan 800.

In one embodiment, the shim emitter electrodes 750 extend past the active area of the ion wind fan 800 into an attachment area 814. Since these non-active end areas (814) of the ion wind fan 800 do not have the same aerodynamic requirements as the shim support members 810, the shim emitter electrodes 750 can be more robustly supported at each end of the fan 800. Furthermore, electrical connections to the shim emitter electrodes 750 can be arranged in the attachment areas 814 or the ion wind fan 800.

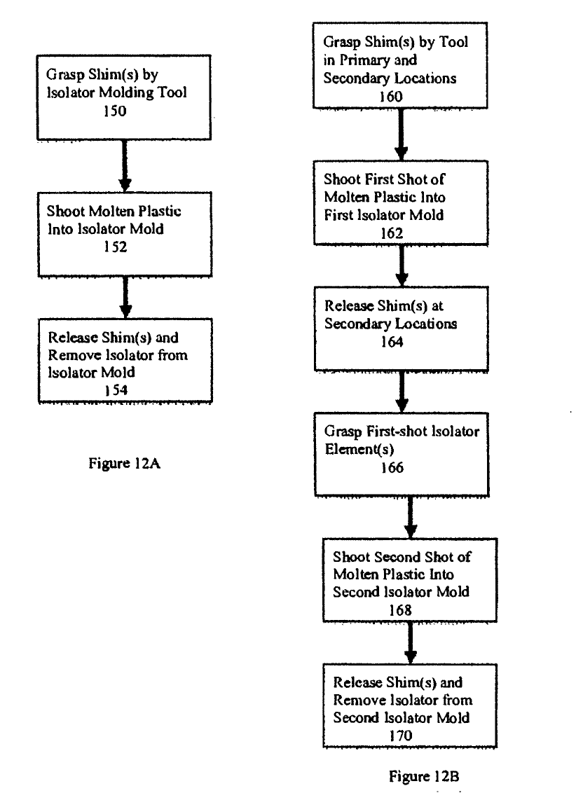

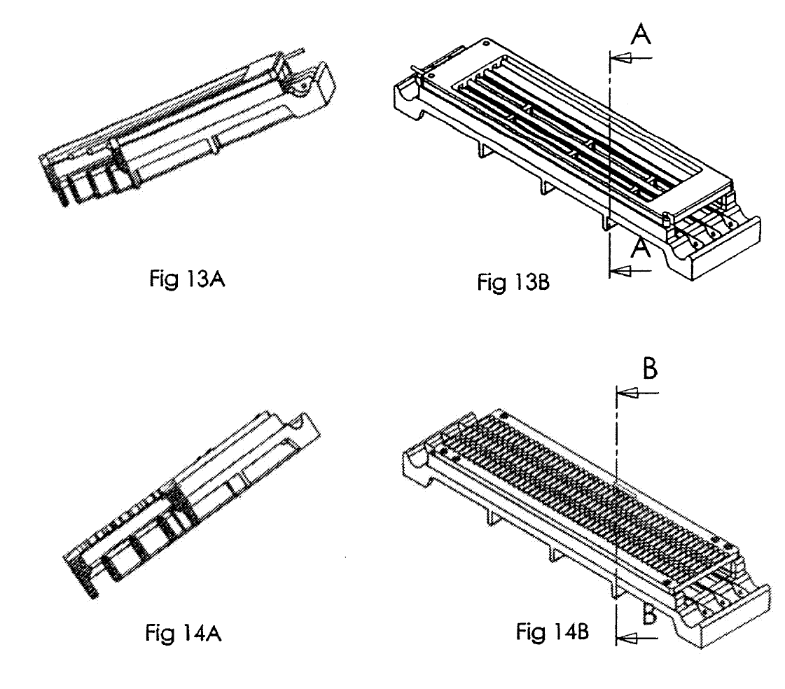

In FIGS. 10-11 and the related descriptions, the ion wind fan 800 using shim emitter electrodes 750 is shown with a curved and contoured collector electrode. However, the shim emitter electrodes can be used with a wire/rod type collector as described above (shown in FIGS. 13A-B), a flat collector as described above (shown in FIGS. 14A-B), or other types of collector electrode geometries.

### Manufacture Method of Ion Wind Fan Having Shim Corona Electrodes

As set forth above, mass-producing an ion wind fan using wire corona electrodes has the potential disadvantage of developing automated tools able to handle wires. This has not been a key issue in ion wind devices in the past, as these devices have been relatively large in scale when compared to ion wind fans used for thermal management of consumer electronics devices. Ion wind fans as described in the present application tend to have very thin corona wires, usually within the range of 10-350 microns in diameter. The precise positioning and tensioning of such thin wires is a challenge for many automated tools suitable for the mass production of an ion wind fan according to embodiments of the present invention.

Using shim emitter electrodes, as described with reference to FIGS. 10 and 11A-C above eliminates the need for wire stringing and tensioning. In one embodiment, the shims electrodes are affixed to the isolator element by injection molding the isolator element directly around the shim electrodes. One embodiment of manufacturing such an ion wind fan is now described with reference to FIG. 12A.

In block 150, an injection molding tool grasps one or multiple shims. The tool grasps the shim at the top edge, where the shim will protrude from the isolator element. The injection molding tool thus forms a cavity containing the non-grasped portion of the shim. In block 152, a molten dielectric substance (such as plastic) is then injected—also referred to as “shot”—into this cavity. After the plastic cools and solidifies, in block 154, the tool releases the grasp around the shim and the cavity, thus releasing the formed isolator element into which the shim has been molded such that it protrudes out forming an emitter electrode, as shown in FIGS. 11A-C, for example. In one embodiment, the tool can be configured to grasp multiple shims simultaneously, and forming the isolator element with the embedded shims in a single shot.

As set forth above, the shim emitter electrodes generally only protrude from the isolator element by approximately 0.2-0.8 mm and are only about 1-5 mils (about 25-225 microns) in thickness. Therefore, holding a thin shim steady while grasping less than a 1 mm strip during the injection of high velocity and high viscosity plastic can present a challenge. Thus, according to another embodiment, the isolator element including the embedded shims can be manufactured according to a process described with reference with FIGS. 12B and 10B.

In block 160 a shim is grasped by the isolator molding tool in both primary and secondary locations. The primary locations will remain exposed, as discussed with reference to FIG. 12A. However the secondary locations will ultimately be covered by the body of the isolator. In FIG. 10B, the primary locations are represented by the reference numeral 824, while the secondary locations are represented by the reference numeral 822.

As can be see in FIG. 10B, in one embodiment, the secondary locations 822 are trapezoid shaped, but other geometric shapes, such as square, rectangular, or triangular can be used. In FIG. 10B, the secondary locations 822 are located along the bottom edge of the shim 750. This is advantageous, since the shim 750 is already grasped from the top at the primary locations 824. In this manner, grasping the shim 750 from both top and bottom, and at both corners and middle regions provides a better and steadier grasp on the shim.

In one embodiment, as shown in FIG. 10B, the body of the first-shot isolator 830 includes two dips along the overhead area (not active ion/corona producing area), exposing more of the shim 750 around the right and left upper corner areas. This enlarges the primary locations 824, thus providing a steadier grasp by the tool.

Furthermore, while two secondary locations 822 are shown in FIG. 10B, any other number of secondary locations can be used, as well as any size of secondary locations 822, within practical limitations. For example, the total area of the primary 824 and secondary 822 locations would generally not exceed 50% of the total area of the side of the shim 750.

In block 162, a first shot of molten dielectric material is injected into the a first isolator mold. This shot will embed the shim 750 into the first shot isolator 830 around the areas not grasped by the tool, that is, in outside of the primary 824 and secondary locations 822. In one embodiment, opening 820 are provided through the shim. One purpose of the openings 820 is to reduce the resistance to the flow of molten plastic created by the shim 750 during injection. Since the flow of injected plastic can warp and move the thin shim 750, such openings 820 (shown in dotted lines in FIG. 10B) can lessen the force exerted on the shim 750 by the plastic injection during the shot of block 162.

As shown in FIG. 10B, in one embodiment, two of the openings 820 (located at either end of the shim) are located in the primary locations 824, and are thus grasped by the tool during the first injection. As such, they do not lower resistance to the plastic injection. However, since they remain exposed after injection molding, the can be used to make electrical and mechanical connections to the shim electrodes.

In block 164, the shim 750 is released at the secondary locations. At this stage of the process, a first-shot version of the isolator element has been formed. In block 166, the first-shot isolator element is re-grasped by the tool. The portion of the tool grasping the primary locations 824 of the shim continues to grasp the primary portions 824. The tool can grasp the first-shot isolator element at any location where no more plastic material is to be injection molded, such as the center portion or the end portions of the first shot isolator element 830 shown in FIG. 10B.

In block 168, a second shot of molten dielectric material is shot into a second isolator mold, while the shim 750 is grasped in the primary locations 824, and the first shot isolator element is grasped at another location. This second shot fills in the secondary locations left exposed on the first-shot isolator element 830. Finally, in block 170, the finished isolator element 802 with shim emitter electrodes embedded into the isolator element 802 is released by the tool, and the isolator and shim electrodes can be removed from the mold.

According to one embodiment, blocks 160-164 are repeated for each shim emitter electrode 750 and shim support member 810 for the ion wind fan. Then after the shim electrodes are embedded into the shim support members, with the secondary locations 822 still being exposed, the first-shot shim support members are inserted into a second molding tool to deliver the second plastic injection of blocks 166-170, thus forming the isolator 802 and embedded shim electrodes 750 of the ion wind fan 800. For example, blocks 160-164 would be repeated (or performed in parallel) three times—once for each emitter 750—to produce the ion wind fan 800 shown in FIGS. 11A-C.

As has been described further above, emitter electrodes have been conventionally been implemented in laboratory environments as pins, wires, or blades. In the laboratory, these emitter geometries are usually suspended above a collector. For example, a blade is generally suspended from the high voltage power supply connection wire that provides the voltage potential difference between the emitter and the collector electrodes.

Several embodiments for embedding a shim electrode into an isolator element of an ion wind fan were described with reference to FIGS. 11 and 10B. However, other emitter electrode geometries can be similarly embedded into an isolator element, according to other embodiments of the invention. According to one embodiment, one or more blades are embedded into an isolator element, in a manner similar to that described with reference to FIGS. 11 and 10B, with the exception of substituting a blade for a shim.

While the example ion wind fan described and pictured above are shown as having two emitter electrodes, any number of emitter electrodes can be used, including one, to create one or more-channel ion wind fans. While most electronics cooling applications using a wire emitter will have between 1-10 emitter electrodes, the invention is not limited to any range of emitter electrodes used.

In the descriptions above, various functional modules are given descriptive names, such as “ion wind fan power supply.” The functionality of these modules can be implemented in software, firmware, hardware, or a combination of the above. None of the specific modules or terms—including “power supply” or “ion wind fan”—imply or describe a physical enclosure or separation of the module or component from other system components.

Furthermore, descriptive names such as “emitter electrode,” “collector electrode,” and “isolator,” are merely descriptive and can be implemented in a variety of ways. For example, the “collector electrode,” can be implemented as one piece of metallic structure, but it can also be made of multiple members spaced apart, and connected by wires or other electrical connections to the same voltage potential, such as ground. Similarly, the isolator can be the substantially frame-like component, but it can have various shapes. The electrodes and the isolator are not limited to any particular material; however, the isolator will generally be made of a dielectric material, such as plastic, ceramic, and other known dielectrics.

What is claimed:

1. An ion wind fan having a longitudinal axis, a first end, and a second end longitudinally opposite the first end, the ion wind fan comprising:
a first wire emitter electrode held in tension between the first end and the second end, the first wire emitter electrode being oriented in the direction of the longitudinal axis;
a collector electrode having an upstream side and a downstream side, the collector electrode comprising a first row of openings connecting the upstream and downstream sides, the first row of openings being oriented along the direction of the longitudinal axis, the openings in the first row of openings having an elongated oval shape having a straight portion and a rounded portion; and
an isolator, wherein the first wire emitter electrode and the collector electrode are attached to the isolator so that the first row of openings is substantially centered above the first wire emitter electrode.

2. The ion wind fan of claim 1, wherein the edges of the openings are rounded on the upstream side of the collector electrode.

3. The ion wind fan of claim 1, wherein size of the openings and the spacing between the openings of the openings of the first row of openings is such that the surface of the collector electrode is between 70-90% open.

4. The ion wind fan of claim 1, wherein size of the openings and the spacing between the openings of the openings of the first row of openings is such that the surface of the collector electrode is between 80-85% open.

5. The ion wind fan of claim 3, wherein the ion wind fan further comprises a second wire emitter electrode held in tension substantially parallel to the first wire emitter electrode, and wherein the collector electrode comprises a second row of openings connecting the upstream and downstream sides, the second row of openings being oriented along the direction of the longitudinal axis, the openings in the second row of openings having an elongated oval shape having a straight portion and a rounded portion, wherein the second row of openings is substantially centered above the second wire emitter electrode.

6. The ion wind fan of claim 5, wherein the spacing distance separating the first row of openings from the second row of openings is substantially the same as the spacing between the openings of the first row of openings.

7. The ion wind fan of claim 1, wherein the openings having an elongated oval shape comprises the openings having a rectangular shape having fillet corners.

8. The ion wind fan of claim 7, wherein the fillet corners of the rectangular shape connect to form a full radius.

9. An ion wind fan comprising:
an isolator element having a first end portion and a second end portion;
a wire emitter electrode attached to the isolator element, the emitter electrode extending from the first end portion to the second end portion of the isolator element; and
a collector electrode attached to the isolator element, the collector electrode having a substantially rectangular shape, a substantially flat surface facing the emitter electrode, and a first set of openings disposed thereon, wherein the first set of openings are substantially aligned with the emitter electrode, the first set of openings having a rectangular portion and a rounded portion.

10. The ion wind fan of claim 1, further comprising:
a first electrical connector to connect the emitter electrode to a power terminal of a high voltage power supply; and
a second electrical connector to connect the collector electrode to a ground terminal of the high voltage power supply, wherein ions are generated along the length of the emitter electrode and move toward the collector electrode thereby creating ion wind, wherein at least a portion of the ion wind flows through the first set of openings.

11. The ion wind fan of claim 1, wherein the collector electrode is held at a substantially constant distance from the emitter electrode by the isolator element.

12. The ion wind fan of claim 1, wherein one or more openings in the set of openings have substantially oval shape.

13. The ion wind fan of claim 1, wherein one or more openings in the set of openings have a substantially elongated oval slit-like shape.

14. The ion wind fan of claim 13, wherein the one or more slit-like openings are oriented perpendicular to the emitter electrode in the plane of the flat surface.

15. The ion wind fan of claim 1, wherein one or more openings in the set of openings have rounded edges facing the emitter electrode.

16. A collector electrode to be used in an ion wind fan, the collector electrode comprising:
a metallic plate-like electrode having a plurality of openings, each opening having a first straight edge, a first rounded edge transitioning into the first straight edge, a second straight edge transitioning into the first rounded edge, the second straight edge being substantially parallel to the first straight edge, and a second rounded edge connecting the second straight edge to the first straight edge.

17. The collector electrode of claim 16, wherein the plurality of openings are arranged in a grid forming a plurality of rows and columns.
